(19) United States
(12) Patent Application Publication
(10) Pub. No.: US 2010/0159189 A1
(43) Pub. Date: Jun. 24, 2010

(54) BASE FABRIC FOR AIRBAG, AIRBAG AND METHOD FOR PRODUCTION OF THE SAME

(75) Inventors: Natsuhiko TAKAGI, Anjo-shi (JP); Akihito SAKAI, Okazaki-shi (JP); Hiromasa MORI, Kiyosu-shi (JP); Satoshi KAWAZOE, Toyohashi-shi (JP); Takahiro ITO, Toyohashi-shi (JP)

Correspondence Address: GREENBLUM & BERNSTEIN, P.L.C., 1950 ROLAND CLARKE PLACE, RESTON, VA, 20191, US

(73) Assignees: TOYOTA BOSHOKU KABUSHIKI KAISHA, Aichi-ken (JP); FUKUI FIBERTECH CO., LTD., Aichi-ken (JP)

(21) Appl. No.: 12/609,645

(22) Filed: Oct. 30, 2009

(30) Foreign Application Priority Data
Dec. 22, 2008 (JP) 2008-326543

(51) Int. Cl. B32B 5/12; B32B 37/00

(52) U.S. Cl. 428/107; 428/221; 156/182

(57) ABSTRACT

The base fabric for an airbag of the present invention comprises a fibrous laminate in which plural fibrous bodies configured by fibers that are oriented in one direction are laminated, and an oriented direction of the fibers in one fibrous body out of two fibrous bodies that are adjacently laminated is different from an oriented direction of the fibers in the other fibrous body. The airbag of the present invention comprises the base fabric for an airbag and is obtained by a method including joining step for joining the plural base fabrics for an airbag so that an internal space having a predetermined shape is formed and cutting step for cutting along a joint section formed by the joining step.

### INCORPORATION BY REFERENCE

The present application claims priority under 35 U.S.C. §119 of Japanese Patent Application No. 2008-326543, filed on Dec. 22, 2008, the disclosure of which is expressly incorporated by reference herein in its entirety.

### BACKGROUND OF THE INVENTION

1. Field of the Invention

The present invention relates to a base fabric for an airbag used for the production of an airbag that is expanded during a vehicular collision so as to absorb and alleviate an impact applied to a passenger, an airbag using the same, and a method for the production of an airbag. More particularly, the present invention relates to a lightweight base fabric for an airbag that has an equally sufficient strength and the like in an oblique direction as the cases in vertical and lateral directions when three pieces, particularly four pieces of the fibrous bodies are laminated and oriented direction of the fibers constituting the fibrous bodies are differed, and that has a highly isotropy; a highly strong and lightweight airbag using the same; and a method for the production of an airbag in which steps are simplified and which offers a high productivity.

2. Related Art

Conventionally, a base fabric for an automobile airbag is manufactured according to various methods (See, for example, Japanese Patent Laid-Open Publication No. JP-A H10-273002 and Japanese Patent Laid-Open Publication No. JP-A 2000-296748). A method of manufacturing the same is known which comprises a warping step of orienting a warp and coating a yarn with oil to facilitate weaving and the like, a weaving step of plain-weaving and hollow-weaving by using a loom, a refining step of removing the oil or the like coated on the yarn, a coating step of coating a top surface and a back surface with a silicone rubber dispersion, a heating step of heating to remove a medium and cure the silicone rubber, a cutting step of cutting into a predetermined shape, and an inspecting step. Through such a manufacturing step, a base fabric for an airbag 100 shown in FIG. 4 is manufactured as a product having a plain weave fabric in which warps 101 and wefts 102 are perpendicular.

### SUMMARY OF THE INVENTION

The base fabric for an airbag 100 produced in the manner described in Japanese Patent Laid-Open Publication No. JP-A H10-273002 or Japanese Patent Laid-Open Publication No. JP-A 2000-296748 is a base fabric using a plain weave fabric, and thus each warp 101 is so woven as to be bent alternately on the top surface and the back surface of each weft 102, for example, as shown in FIG. 4(A). Therefore, an internal stress caused due to transformation occurs in a bent section (for example, 101a), resulting in a tendency that the strength is more decreased than that originally inherent in the fiber. Moreover, since the yarn is bent, a required yarn length is longer than the length of a fabric, which is unfavorable in view of weight-saving.

Furthermore, while a plain weave fabric has a sufficient strength and the like in two directions, i.e., a vertical direction and a lateral direction, it does not necessarily have the equal strength and the like, in an oblique direction. Therefore, a product having an anisotropy in strength and the like is sometimes generated. This imposes a restriction on a material extraction taken from a base fabric, a design for an airbag and the like. In this manufacturing method, the operation becomes complicated in that it is necessary to perform highly-dense hollow weaving by using a loom, and further, refinery is necessary, for example, and also, the number of steps is large. Thus, it is difficult to say that the productivity is high.

The present invention has been achieved in view of the above-described conventional situations, and an objective thereof is to provide a lightweight base fabric for an airbag that has an equally sufficient strength and the like in an oblique direction as the cases in vertical and lateral directions when three pieces, particularly four pieces of the fibrous bodies are laminated and oriented direction of the fibers constituting the fibrous bodies are differed, and that has a highly isotropy; a highly strong and lightweight airbag using the same; and a method for the production of an airbag in which steps are simplified and which offers a high productivity.

The base fabric for an airbag of the present invention is one comprising a fibrous laminate in which plural fibrous bodies configured by fibers that are oriented in one direction are laminated, and is characterized in that an oriented direction of the fibers in one fibrous body out of two fibrous bodies that are adjacently laminated is different from an oriented direction of the fibers in the other fibrous body.

In the present invention, a base fabric for an airbag has a sufficient strength and the like, and is lightweight since plural fibrous bodies configured by fibers that are oriented in one direction are laminated and an oriented direction of the fibers in one fibrous body out of two fibrous bodies that are adjacently laminated is different from an oriented direction of the fibers in the other fibrous body. In addition, laminated fibers are not bent—unlike a woven fabric—and thus, as compared to a woven textile having the same length, the yarn length (fiber length) that is consumed is shorter. Therefore, weight-saving can be easily achieved, and the strength of the fiber is not decreased due to internal stress occurring by bending. Moreover, when three or more fibrous bodies, particularly four or more fibrous bodies, are laminated while setting the fibrous bodies so that orienting directions of the respective fibers constituting each of the fibrous bodies are differed, a base fabric having an equivalent strength and expansion not only in a vertical direction and a lateral direction but also in an oblique direction can be achieved. Unlike a base fabric using the conventional plain weave fabric, a base fabric of the present invention can be one having no anisotropy, that is, one having at least a low anisotropy. Therefore, the flexibility of cutting is increased, and the yield can be improved. In addition, since the orienting direction of the fiber can be arbitrarily set, the orienting direction can be set to a direction optimal for each product.

The airbag of the present invention is characterized in that it is produced using the above base fabric for an airbag of the invention.

According to the airbag of the present invention, it has a highly strength and is lightweight because it is produced using the above base fabric for an airbag of the invention.

Additionally, the method for the production of an airbag of the present invention is characterized by comprising a fibrous body fabricating process in which a fibrous body is fabricated by orienting fibers in one direction, a fibrous laminate fabricating process in which a fibrous laminate is fabricated by laminating plural fibrous bodies while setting the fibrous bodies so that oriented directions of the respective fibers of the adjacent fibrous bodies are differed, a base fabric fabricating process in which a base fabric for an airbag is fabricated by integrally joining plural fibrous laminates, a joining process in which plural base fabrics for an airbag having fibrous laminate are joined so as to form an internal space having a predetermined shape, and a cutting process in which the integrated is cut along a joint section formed by the joining process.

According to the method for the production of an airbag of the present invention, a weaving step and a refining step by a loom, which are necessary in the conventional technology, are rendered unnecessary, and thus, the operation is simple, the steps are simplified, and the productivity can be improved. Moreover, since the method does not comprise a process for weaving with a loom, a load applied to fibers during the production can be decreased, and thus, the strength, expansion and the like, originally inherent in the fiber are not impaired.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIGS. 1(A) to 1(D) are schematic diagrams of processes for production of a base fabric for an airbag and an airbag according to Example, wherein FIG. 1(A) shows a process for adhering a thermoplastic resin film to a fibrous laminate, FIG. 1(B) shows a process for overlapping two pieces of base fabrics for an airbag with each other, FIG. 1(C) shows a process for fabricating plural airbags (base substance) by joining predetermined locations, and FIG. 1(D) shows a process for cutting along a joint section to cut out an airbag (base body).

FIGS. 2(A) to 2(D) are diagrams of the orienting direction of fibers of a fibrous body constituting a base fabric for an airbag, wherein a winding direction of a base fabric for an airbag in FIG. 2(A) is taken for a reference, FIG. 2(B) shows a state where an angle of +90 degrees is formed, FIG. 2(C) shows a state where an angle of +45 degrees is formed, FIG. 2(D) shows a state where an angle of −45 degrees is formed, and FIG. 2(E) shows a state where four pieces of base fabrics are overlapped on top of one another.

FIG. 3 is a perspective view of a laminate wherein two pieces of fibrous bodies of which the respective fibers are engaged by a fiber for linking are laminated.

FIGS. 4(A) and 4(B) are diagrams according to a base fabric for an airbag using a conventional plain weave fabric, in which FIG. 4(A) is a lateral side view and FIG. 4(B) is a plane view.

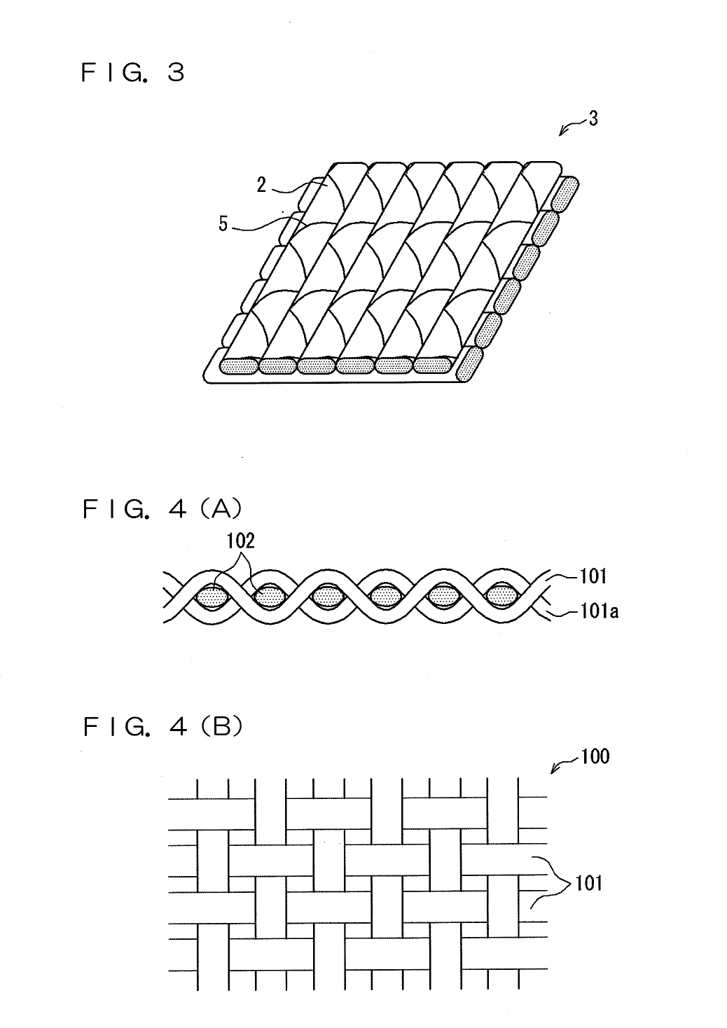

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### 1. Base Fabric for Airbag

The base fabric for an airbag of the present invention comprises a fibrous laminate in which plural fibrous bodies configured by fibers that are oriented in one direction is laminated, and an oriented direction of the fibers in one fibrous body out of two fibrous bodies that are adjacently laminated is different from an oriented direction of the fibers in the other fibrous body.

The “fiber” is not particularly limited and the various types of fibers such as a synthetic fiber and a natural fiber comprising hemp or cotton can be used. Among these, a synthetic fiber is preferred. The synthetic fiber is not particularly limited and the various types of synthetic fibers can be used. Examples of the synthetic fiber include a polyamide-based fiber such as nylon 6 fiber and nylon 66 fiber, a polyester-based fiber such as polyethylene terephthalate fiber, polybutylene terephthalate fiber and polytrimethylene terephthalate, a polyacryl-based fiber, a polyolefin-based fiber such as polypropylene fiber, and the like. As the synthetic fiber, a polyamide-based fiber and a polyester-based fiber are particularly preferred. One type of the fiber may be used and two or more types of the fibers may be used in combination. Only one type of the fiber is often used.

A sheath-core type fiber can be used as the fiber constituting the fibrous body, which comprises a sheath section of a low melting point and a core section of a high melting point (it is not melted at a temperature at which the sheath section is melted). Examples of the sheath-core type fiber include: a sheath-core type fiber in which the sheath section is made of polyester having a relatively low melting point and the core section is made of polyester having a relatively high melting point; a sheath-core type fiber in which the sheath section is made of polyethylene and the core section is made of polypropylene; and the like. In the case where the sheath-core type fiber is used, when a base fabric for an airbag is produced in which plural fibrous bodies are integrally joined and the level of air permeability is retained low, a thermoplastic resin film, an adhesive and the like may be used. These, however, are not essential and may be joined by heating only to achieve integration.

The fineness of the fiber is not particularly limited and a fiber having an appropriate fineness is preferably used depending upon its type, shape, dimension and the like of an airbag. The fineness is preferably in the range from 100 to 1,000 dtex, and particularly from 200 to 500 dtex. When the fineness of the fiber is in the range from 100 to 1,000 dtex, the base fabric for an airbag (fibrous body and fibrous laminate) can be rendered thin and lightweight, being favorable.

The “fibrous body” is fabricated by orienting fibers in one direction. The yarn density of the fibrous body is not particularly limited and is preferably in the range from 10 to 80 yarns per inch, and particularly from 20 to 60 yarns per inch. When the yarn density is in the range from 10 to 80 yarns per inch, the fibrous body can be rendered thin and the fibers can be evenly aligned, being favorable. Although the finenesses of fibers constituting the fibrous body may be the same or different, in order to realize the isotropy of strength in the base fabric for an airbag, the finenesses are preferably the same.

The “fibrous laminate” is one wherein pluralities of fibrous bodies are laminated. In the fibrous laminate, an oriented direction of the fibers in one fibrous body out of two fibrous bodies that are adjacently laminated is different from an oriented direction of the fibers in the other fibrous body. Thereby, this configuration makes it possible to give a fibrous laminate sufficient strength, expansion and the like at least in a direction in which the fibers are unidirectionally oriented. The laminating number of fibrous body for the fibrous laminate is preferably in the range from 2 to 8, more preferably from 4 to 8, and particularly from 4 to 6. For example, when the laminating number thereof is 4, a fibrous laminate having sufficient strength, expansion and the like in any direction, i.e., a vertical direction, a lateral direction, and a direction that forms an angle of substantially 45 degrees relative to these two directions, may be achieved. At the same time, when the material, fineness, yarn density and the like of fibers constituting the respective fibrous bodies are appropriately selected, a fibrous laminate having strength and the like that are different depending upon a direction may be achieved. Depending upon attributes such as a type of an airbag, the fibrous laminate having this anisotropy may be used.

The roughness and fineness of the fibrous laminate can be estimated by a cover factor. The cover factor is preferably not more than 2,500, and particularly in the range from 1,500 to 2,000. When the cover factor is not more than 2,500, a fibrous laminate that is more lightweight than a plain weave fabric normally used as a base fabric for an airbag can be achieved, being favorable.

The cover factor is a numerical value expressed by a total sum of products of each square root of the fineness of each of the fibrous bodies and a yarn density.

The orienting direction of fibers constituting each of the fibrous bodies laminated can be set to a direction that is one direction of the base fabric for an airbag (a direction in which the base fabric for an airbag is wound), and a direction that forms an angle of the range from ±20 to ±90 degrees relative to the first direction. Angles formed by the orienting direction of fibers constituting the respective fibrous bodies may be the same or different. However, a substantially same angle is preferable. In addition, orienting directions of fibers constituting a greater number of fibrous bodies, in particular, all of the fibrous bodies, out of the laminated fibrous bodies, are preferably different. Further, it is particularly preferable that the orienting directions of fibers constituting a greater number of fibrous bodies, in particular, all of the fibrous bodies be different and angles formed by the orienting directions of fibers constituting each of the fibrous bodies be substantially the same. In this manner, a fibrous laminate having high isotropy can be achieved.

More particularly, when n pieces of fibrous bodies are laminated to fabricate a fibrous laminate, a fibrous laminate in which an angle formed by the orienting directions of fibers constituting each of the fibrous bodies is in the range from 160/n degrees to 200/n degrees is preferable. With such a fibrous laminate, when the laminating number of the fibrous body is, for example, two, the angle is in the range from 80 to 100 degrees; when the laminating number is three, the angle is in the range from about 53 to 67 degrees; when the laminating number is four, the angle is in the range from 40 to 50 degrees. As a result, the angle formed by the orienting direction of fibers constituting each of the fibrous bodies is substantially the same, thereby achieving a fibrous laminate having a sufficient strength and a high isotropy, being preferable.

It is preferable that a fibrous body constituting a top surface layer on one surface side and a fibrous body constituting a top surface layer on the other surface side are engaged by a fiber for linking in the fibrous laminate, that the fibers constituting the top surface layer on one surface side are engaged by a fiber for linking to integrate the fibrous body, and that the fibers constituting the top surface layer on the other surface side are engaged by a fiber for linking to integrate the fibrous body. In this case, the fibers constituting the fibrous bodies are integrally held and are not dispersed. Thus, handling is easy. When the laminating number of the fibrous body is three or more, a fibrous body constituting a layer between the top surface layer on one surface side and the top surface layer on the other surface side, and fibers constituting this fibrous body may be engaged or may not be engaged by a fiber for linking, with the fibrous body constituting a top surface layer on one surface side and the fibrous body constituting a top surface layer on the other surface side, and fibers constituting these fibrous bodies. In addition, a linking fiber for fixing the top surface layer on one surface side and the top surface layer on the other surface side, a linking fiber for fixing fibers constituting the top surface layer on one surface side, and a linking fiber for fixing fibers constituting the top surface layer on the other surface side may all be the same each other (a single seamless fiber) and may be different fibers. Furthermore, the material and finenesses of these linking fibers may be the same or may be different. The linking fiber is not particularly limited, a synthetic fiber or a natural fiber that is similar to a fiber constituting the fibrous body may be used, and in particular, a polyester-based fiber and a polyamide-based fiber are preferable. The fineness of the linking fiber is not particularly limited and a linking fiber having an appropriate fineness is preferably used depending upon the fineness of fibers constituting the fibrous body. The fineness is preferably in the range from 30 to 100 dtex, more preferably from 40 to 90 dtex, and particularly from 50 to 60 dtex. When the fineness of the linking fiber is in the range from 30 to 100 dtex, the physical properties of the fibrous body are not affected, being preferable.

In the base fabric for an airbag of the present invention, it is preferable that the fibrous bodies constituting the fibrous laminate, i.e., plural fibrous bodies laminated are integrally joined and the level of air permeability is retained sufficiently low. The integration and the suppression of air permeability may be achieved by any method. For example, a base fabric for an airbag may be configured in the way where the fibrous bodies constituting the fibrous laminate are integrally joined by a thermoplastic resin. In this case, to achieve a base fabric for an airbag having a more sufficient strength and the like, it is preferable that not only fibrous bodies are joined, but also the thermoplastic resin is impregnated in the respective fibrous bodies and thus the whole fibrous laminate be integrally and firmly joined. Such a base fabric for an airbag can be manufactured by employing a method using a thermoplastic resin film for integration of the fibrous bodies, as described later.

### 2. Airbag

The airbag of the present invention is one produced using the base fabric for an airbag of the present invention. Therefore, a lightweight airbag having a sufficient strength, expansion and the like can be achieved. The types of the airbag is not particularly limited and can be applied for an automobile airbag such as a driver seat airbag, a passenger seat airbag, side airbag, a curtain airbag, a knee airbag, and an ITS head airbag.

### 3. Method for Production of Airbag

The method for the production of an airbag of the present invention comprises a fibrous body fabricating process in which a fibrous body is fabricated by orienting fibers in one direction, a fibrous laminate fabricating process in which a fibrous laminate is fabricated by laminating plural fibrous bodies while setting the fibrous bodies so that oriented directions of the respective fibers of the adjacent fibrous bodies are differed, a base fabric fabricating process in which a base fabric for an airbag is fabricated by integrally joining plural fibrous laminates, a joining process in which plural base fabrics for an airbag having fibrous laminate are joined so as to form an internal space having a predetermined shape, and a cutting process in which the integrated is cut along a joint section formed by the joining process.

In the “fibrous body fabricating process”, fibers forwarded from a device, while keeping a linear shape, are unidirectionally oriented in the same direction, and a fibrous body is thereby fabricated. The fibrous body can be fabricated using a machine such as a multi-axis fabric laminating machine. Fixing of fibers using a fiber for linking described below may be simultaneously performed, as needed.

In the “fibrous laminate fabricating process”, a fibrous laminate is fabricated by laminating plural fibrous bodies while setting the fibrous bodies so that oriented directions of the respective fibers of the adjacent fibrous bodies are differed and a fibrous laminate is thereby fabricated. When the fibrous body is fabricated using a machine such as a multi-axis fiber laminating machine in the fibrous laminate fabricating process, each of the fibrous bodies to be fabricated is continuously laminated sequentially. The fibrous body fabricating process and the fibrous laminate fabricating process can be continuously and integrally implemented. Moreover, it is preferable that fibrous bodies to be at least of the top surface layers of the laminate and each of the fibers constituting these be engaged by a fiber for linking forwarded from a device and be integrally fixed so that the respective fibrous bodies and fibers are not easily dispersed in the fibrous laminate fabricating process.

In the “base fabric fabricating process”, plural laminated fibrous bodies are integrally joined. In this process, it is preferable that the air permeability is sufficiently suppressed. The method for integrally joining and permeability suppressing is not particularly limited. There are various types of methods and examples thereof include one wherein a thermoplastic resin film is adhered to the fibrous laminate, the film in the resultant material is fused by heating and flown so as to impregnate the thermoplastic resin, which is followed by cooling. In this way, each fibrous body is integrated and the level of air permeability is retained low. Examples of the thermoplastic resin film include a polyolefin-based resin film, a polyamide-based resin film, a polyester-based resin film and the like. Additionally, a thermoplastic elastomer film such as a thermoplastic urethane-based elastomer film and a thermoplastic olefin-based elastomer film can be used in the same manner for the production of the base fabric for an airbag.

As long as it is possible to integrally join and hold the laminated fibrous bodies and to sufficiently retain low the level of air permeability of the fabricated base fabric for an airbag, the thermoplastic resin film or the like may be adhered to one surface side of the fibrous laminate or to both surfaces thereof. Moreover, the thickness of the thermoplastic resin film and the like is not particularly limited as long as it is possible to achieve integration of the fibrous bodies and suppress the air permeability of the base fabric for an airbag. The thickness is preferably set depending upon the condition such as yarn density and thickness of each of the fibrous bodies; whether the film is used for one surface side or both surfaces, of the fibrous body, and the like. The thickness thereof is preferably not longer than 100 μm, more preferably in the range from 10 to 100 μm, and particularly from 10 to 50 μm.

Moreover, a base fabric for an airbag may be fabricated by impregnating an adhesive from a single surface or both surfaces of the fibrous laminate and, as needed, by heating to cure the adhesive. In this case, it may be possible to fabricate by impregnating the adhesive in the fibrous laminate and coating the both surfaces with the adhesive, and, as needed, by heating to cure the adhesive. In addition, it may be possible to fabricate by impregnating the adhesive in the fibrous laminate and adhering a thermoplastic resin film to a single surface or both surfaces, and, as needed, by heating to cure the adhesive thereby to integrate the laminated fibrous body, and also, joining the thermoplastic resin film on a single surface or both surfaces of the fibrous laminate. Even when any method is selected, it is possible to fabricate a base fabric for an airbag in which the level of air permeability is retained sufficiently low.

In the “joining process”, the plural base fabrics for an airbag are joined so that an internal space having a predetermined shape defined by the type, shape, dimension or the like of the air bag is formed. The joining method is not particularly limited. For example, when thermal bonding is enabled as in a case of fabricating the base fabric for an airbag by integrating the plural fibrous bodies with a thermoplastic resin film, (for example, the above-described base fabric for an airbag formed using the fibrous laminate in which at least a single surface or both surfaces is joined with the thermoplastic resin film), the plural base fabrics for an airbag are laminated, positions to be joined are heated, applied pressure, and thermally bonded, followed by cooling. In this way, the joining is enabled. Moreover, the positions to be joined are coated with an adhesive, and as needed, heated and applied pressure. In this way, the joining is also enabled.

In the “cutting process”, a laminated article formed in the joining process is cut along the joint section, whereby a base body for an airbag can be manufactured. When the joint section has a wide width, the cutting may be performed at the joint section or performed along an outer peripheral line of the joint section or performed along an outer peripheral edge slightly outward (for example, 10 to 20 mm outward) of the outer peripheral line. The base body for an airbag thus manufactured is examined for quality, and thereafter, other required members are attached thereto. In this way, this product can be assembled, as an automobile airbag, to be used at a predetermined position of an automobile.

The present invention can be utilized in the technical field of a base fabric for an airbag and an airbag for automobiles. In particular, the present invention can be preferably utilized in the technical field of a base fabric for an airbag used for a curtain shield airbag.

### Example

Hereinafter, the invention will be more specifically described using figures.

### 1. Configuration of Base Fabric for Airbag

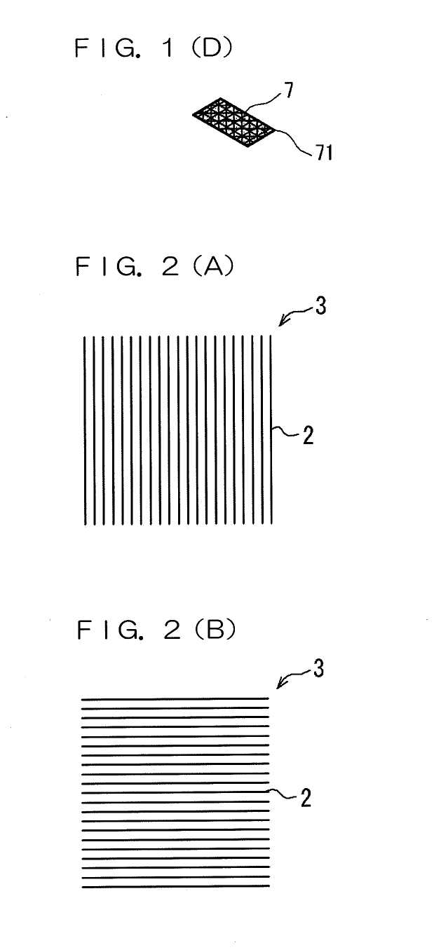

A base fabric for an airbag 1 according to the embodiment is provided with a fibrous laminate 4 shown in FIG. 2(E) in which plural fibrous bodies 3 configured by fibers 2 that are oriented in one direction are laminated. In the fibrous laminate 4, an oriented direction of the fibers 2 in one fibrous body 3 out of two fibrous bodies 3 that are adjacently laminated is different from an oriented direction of the fibers 2 in the other fibrous body 3. Herein, four pieces of the fibrous bodies 3 [FIGS. 2(A) to (D)] are laminated, and unidirectionally orienting directions of the fibers 2 constituting each of the fibrous bodies 3 respectively form an angle of substantially 45 degrees and they are spaced at substantially equal intervals [FIG. 2(E)].

The cover factor of the fibrous laminate 4 was 1729.

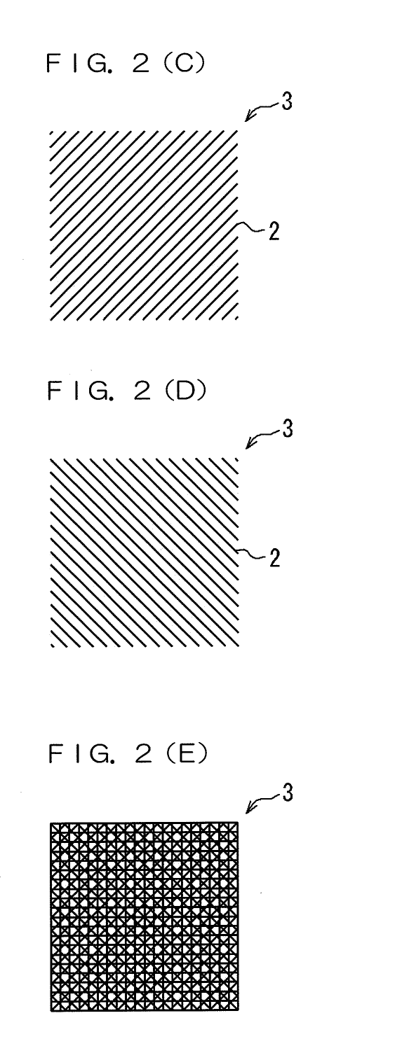

The fiber 2 constituting the fibrous body 3 is made of a polyester resin, and the fineness of the fiber 2 is 470 dtex. The yarn density of the fibrous body 3 is 20 yarns per inch. Finenesses of the fibers 2 constituting each of the fibrous bodies 3 and yarn densities of the fibrous bodies 3 are independently all the same. Moreover, the fibrous bodies 3 constituting a top surface layer of one surface side and the other surface side of the fibrous laminate 4, and the fibers 2 constituting these fibrous bodies 3 are mutually engaged by a fiber for linking 5, as shown in FIG. 3. As the linking fiber 5, a fiber that is made of a polyester resin and that has a fineness of 50 dtex was used.

Thermoplastic resin films 6 adhered on the both surfaces of the fibrous laminate 4 are heated and melted, and then the melted thermoplastic resin is flown and impregnated in the interior of the laminated fibrous bodies 3 (fibrous laminate 4) to integrate the fibrous bodies 3. The resultant material is further applied pressure, whereby a base fabric for an airbag 1 is manufactured. As the thermoplastic resin film 6, a film that is made of an olefin-based elastomer and that has a thickness of 50 μm was used.

### 2. Production of Base Fabric for Airbag and Airbag

The base fabric for an airbag 1 and an airbag 7 (which is, in reality, a bag-shaped product that serves as a base body of the airbag, and when required members are attached thereto, an airbag is completed) were manufactured as follows.

A multi-axis fiber laminating machine was used to continuously fabricate fibrous bodies 3 in which the fibers 2 are oriented in one direction and to engage independently the fibrous bodies 3 constituting a top surface layer of one surface side and the other surface side of the fibrous laminate 4, and the fibers 2 constituting these fibrous bodies 3. Thereby four pieces of fibrous bodies 3 were sequentially fabricated as shown in FIGS. 2(A) to (D) and laminated so that the oriented directions of the fibers 2 constituting the fibrous bodies 3 were differed by substantially 45 degrees as shown in FIG. 2(E).

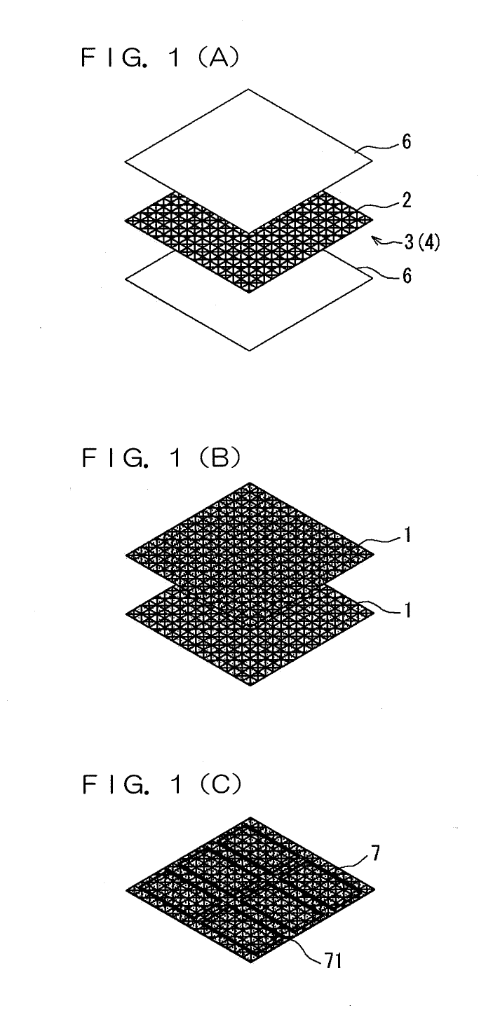

After that, the thermoplastic resin films 6 were adhered to the both surfaces of the fibrous laminate 4 in which the fibrous bodies 3 were laminated, as shown in FIG. 1(A). Subsequently, the resultant material was heated so as to melt the films, and the flowing thermoplastic resin was impregnated in the interior of the fibrous bodies 3 (fibrous laminate 4), which was followed by cooling so as to integrate the fibrous bodies 3 and fabricate a base fabric for an airbag 1 shown in FIG. 1(B). Then, an adhesive was coated to surfaces of two base fabrics for an airbag 1 so that an internal space having a predetermined shape was formed and the two base fabrics were adhered as shown in FIG. 1(C). The resultant material was cut along an outer peripheral edge of a joint section 71 shown in FIG. 1(D), whereby an airbag (base body) 7 was manufactured.

### 3. Effects of the embodiment

According to the base fabric for an airbag 1 and the airbag 7 of the embodiment, four pieces of the fibrous bodies 3 constituting the fibers 2 oriented in one direction are laminated, unlike the conventional plain weave fabric, the fibers are not bent, the internal stress is hard to occur, and no load is applied to the fibers. Thus, it is possible to increase the strength. Comparing base fabrics for an airbag having the same dimension, the length and density of the fibers 2 become small, making it possible to implement weight-saving. In addition, since four pieces of the fibrous bodies 3 are laminated so as to form all angles from oriented directions of the fibers 2 of substantially 34 degree and to keep substantially equal intervals, as compared to the plain weave fabric, the anisotropy can be more greatly decreased, the degree of freedom in cutting is more increased, and also, the yield can be improved.

Further, the finenesses and yarn densities of the fibers 2 constituting the fibrous bodies 3 are independently the same, and thus, the strength, expansion and the like in an oblique direction are equal to those of a vertical direction and a lateral direction. As a result, the base fabric for an airbag 1 and the airbag 7 having a sufficient isotropy can be achieved. Additionally, the fibrous laminate 4 is integrally joined by a thermoplastic resin that is obtained as a result of the thermoplastic resin film 6 being melted, flown, and impregnated. Thus, the level of air permeability is retained sufficiently low. The method is one fabricating a base fabric for an airbag 1 using the thermoplastic resin film 6, and thus, complicated operations such as coating and thermal curing become unnecessary and a manufacturing process can be simplified as compared with the conventional technology in which a dispersion containing silicone rubber is used. Moreover, since the fibrous body 3 constituting the top surface layer and the fibers 2 constituting the fibrous body 3 are engaged by the linking fiber 5, the fibrous bodies 3 and the fibers 2 are not dispersed. Thus, handling is easy and the yield can be improved.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

In the embodiment, four pieces of the fibrous bodies 3 were laminated so as to have angles formed by the oriented directions of the fibers 2 constituting the fibrous bodies 3 of substantially 45 degrees. The present invention, however, is not limited thereto. For example, three pieces of the fibrous bodies 3 may be laminated to have angles formed by the oriented directions of substantially 60 degrees, and alternately, two pieces of the fibrous bodies 3 may be laminated to have angles formed by the oriented directions of substantially 90 degrees. Moreover, five pieces of the fibrous bodies 3 may be laminated to have angles formed by the oriented directions of substantially 36 degrees, and alternately, six pieces of the fibrous bodies 3 may be laminated to have angles formed by the oriented directions of substantially 30 degrees. Further, in the embodiment, two pieces of base fabrics for an airbag 1 were joined. The present invention, however, is not limited thereto. Three or more pieces of base fabrics for an airbag 1 may be joined.

In the embodiment, a fiber made of a polyester resin was used as the fiber 2 constituting all of the fibrous bodies 3. The present invention, however, is not limited thereto, and a sheath-core type fiber may also be used. When the sheath-core type fiber is used, the fibers are thermally bonded one another by heating to join the fibrous bodies 3 integrally without using a thermoplastic resin film, an adhesive and the like. Additionally, the angles formed by the oriented directions of the fibers 2 constituting the respective fibrous bodies 3 were all the same in the embodiment. The present invention, however, is not limited thereto, and the different angles may be employed. Moreover, the thermoplastic resin films 6 were adhered to both surfaces of the fibrous laminate 4 in the embodiment. The present invention, however, is not limited thereto, and the thermoplastic resin film 6 may be adhered only to a single surface of the fibrous laminate 4. Further, in the embodiment, the fibers 2 constituting the fibrous bodies 3 were engaged by a linking fiber 5. The present invention, however, is not limited thereto, and the linking fiber 5 may not be used.

What is claimed is:

1. A base fabric for an airbag, comprising a fibrous laminate in which plural fibrous bodies configured by fibers that are oriented in one direction are laminated,
wherein an oriented direction of the fibers in one fibrous body out of two fibrous bodies that are adjacently laminated is different from an oriented direction of the fibers in the other fibrous body.

2. The base fabric for an airbag according to claim 1,
wherein a fibrous body constituting a top surface layer on one surface side and a fibrous body constituting a top surface layer on the other surface side are engaged by a fiber for linking in said fibrous laminate,
wherein the fibers constituting the top surface layer on said one surface side are engaged by a fiber for linking to integrate said fibrous body, and
wherein the fibers constituting the top surface layer on said other surface side are engaged by a fiber for linking to integrate said fibrous body.

3. The base fabric for an airbag according to claim 1,
wherein fibrous bodies are laminated by number of n, and an angle formed by oriented directions of the fibers constituting said fibrous bodies is between 160/n degrees and 200/n degrees.

4. The base fabric for an airbag according to claim 1,
wherein said fibrous bodies constituting said fibrous laminate is integrally joined with a thermoplastic resin.

5. An airbag characterized in that said airbag is produced using said base fabric for an airbag according to claim 1.

6. A method for production of the airbag according to claim 5, comprising:
fabricating a fibrous body while orienting fibers in one direction;
fabricating a fibrous laminate by laminating plural fibrous bodies while setting said fibrous bodies so that oriented directions of the respective fibers of the adjacent fibrous bodies are differed;
fabricating a base fabric for an airbag by integrally joining said fibrous bodies that are laminated;
joining plural base fabrics for an airbag having said fibrous laminate so that an internal space having a predetermined shape is formed; and
cutting along a joint section formed by the joining.
